(19) United States
(12) Patent Application Publication
(10) Pub. No.: US 2014/0351767 A1
(43) Pub. Date: Nov. 27, 2014

(54) POINTER-BASED DISPLAY AND INTERACTION

(71) Applicants: James Darrow Linder, Brea, CA (US); Adam Escobedo, Amelia, OH (US); Derek Muktarian, Milford, OH (US)

(72) Inventors: James Darrow Linder, Brea, CA (US); Adam Escobedo, Amelia, OH (US); Derek Muktarian, Milford, OH (US)

(73) Assignee: SIEMENS PRODUCT LIFECYCLE MANAGEMENT SOFTWARE INC., Plano, TX (US)

(21) Appl. No.: 13/900,120

(22) Filed: May 22, 2013

(51) Int. Cl. G06F 3/0481

(52) U.S. Cl. CPC G06F 3/04812
USPC 715/856

(57) ABSTRACT

Methods for product data management and corresponding systems and computer-readable mediums. A method includes displaying a user interface including at least one target object having a hover area. The method includes detecting that a user-controlled pointer is moved into the hover area and held in place for a first predetermined amount of time. The method includes displaying a dialog associated with the target object in response to the detecting. The method includes receiving configuration data from a user through the dialog and saving the received configuration data. The method can include receiving a selection of an access handle associated with the target object and, in response, activating the access handle and displaying at least one manipulation handle in the user interface.

### TECHNICAL FIELD

The present disclosure is directed, in general, to computer-aided design, visualization, and manufacturing systems, product lifecycle management (“PLM”) systems, and similar systems, that manage data for products and other items (collectively, “Product Data Management” systems or PDM systems).

### BACKGROUND OF THE DISCLOSURE

PDM systems manage PLM and other data. Improved systems are desirable.

### SUMMARY OF THE DISCLOSURE

Various disclosed embodiments include methods for product data management and corresponding systems and computer-readable mediums. A method includes displaying a user interface including at least one target object having a hover area. The method includes detecting that a user-controlled pointer is moved into the hover area and held in place for a first predetermined amount of time. The method includes displaying a dialog associated with the target object in response to the detecting. The method includes receiving configuration data from a user through the dialog and saving the received configuration data. The method can include receiving a selection of an access handle associated with the target object and, in response, activating the access handle and displaying at least one manipulation handle in the user interface.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 illustrates a block diagram of a data processing system in which an embodiment can be implemented;

FIG. 2 illustrates an example of a simplified user interface in accordance with disclosed embodiments;

FIG. 3 illustrates an exemplary user interface including access handles in accordance with disclosed embodiments; and

FIG. 4 illustrates a flowchart of a process in accordance with disclosed embodiments.

### DETAILED DESCRIPTION

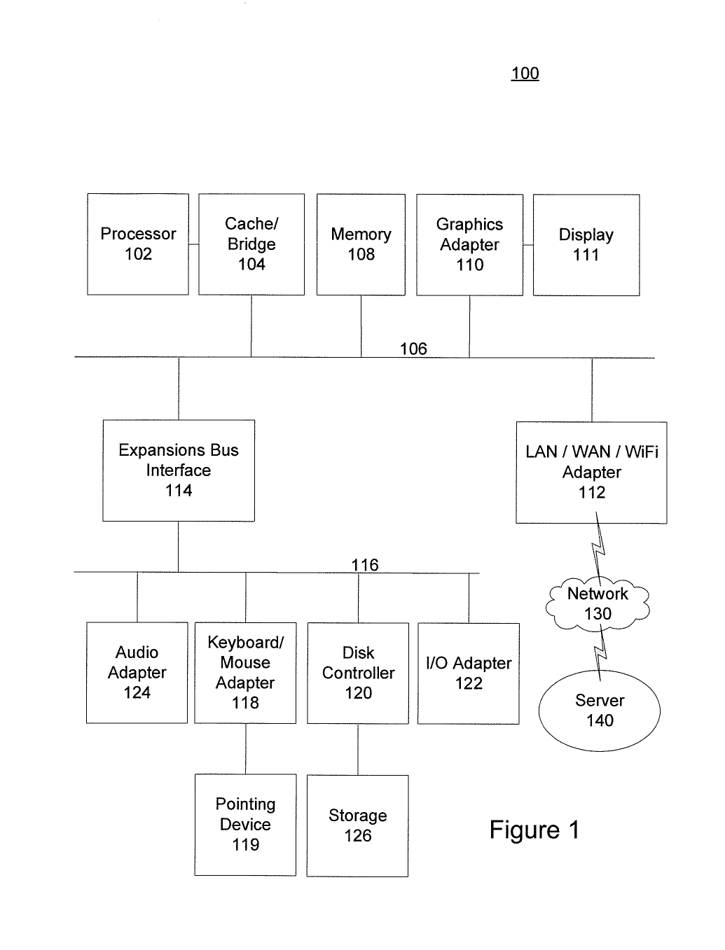

FIGS. 1 through 4, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. The numerous innovative teachings of the present application will be described with reference to exemplary non-limiting embodiments.

Disclosed embodiments include systems and methods for intuitively displaying information and interaction dialogs in a user interface. Disclosed embodiments are particularly advantageous in, but not limited to, PDM systems that display objects with customizable parameters, options, and other information.

FIG. 1 illustrates a block diagram of a data processing system in which an embodiment can be implemented, for example, as a PDM system particularly configured by software or otherwise to perform the processes as described herein, and in particular as each one of a plurality of interconnected and communicating systems as described herein. The data processing system illustrated includes a processor 102 connected to a level two cache/bridge 104, which is connected in turn to a local system bus 106. Local system bus 106 may be, for example, a peripheral component interconnect (PCI) architecture bus. Also connected to local system bus in the illustrated example are a main memory 108 and a graphics adapter 110. The graphics adapter 110 may be connected to display 111.

Other peripherals, such as local area network (LAN)/Wide Area Network/Wireless (e.g. WiFi) adapter 112, may also be connected to local system bus 106. Expansion bus interface 114 connects local system bus 106 to input/output (I/O) bus 116. I/O bus 116 is connected to keyboard/mouse adapter 118, disk controller 120, and I/O adapter 122. Disk controller 120 can be connected to a storage 126, which can be any suitable machine usable or machine readable storage medium, including but not limited to nonvolatile, hard-coded type mediums such as read only memories (ROMs) or erasable, electrically programmable read only memories (EEPROMs), magnetic tape storage, and user-recordable type mediums such as floppy disks, hard disk drives and compact disk read only memories (CD-ROMs) or digital versatile disks (DVDs), and other known optical, electrical, or magnetic storage devices.

Also connected to I/O bus 116 in the example illustrated is audio adapter 124, to which speakers (not shown) may be connected for playing sounds. Keyboard/mouse adapter 118 provides a connection for a pointing device 119, such as a mouse, trackball, trackpointer, touchscreen, etc., that can control a cursor or pointer as described herein.

Those of ordinary skill in the art will appreciate that the hardware illustrated in FIG. 1 may vary for particular implementations. For example, other peripheral devices, such as an optical disk drive and the like, also may be used in addition or in place of the hardware illustrated. The illustrated example is provided for the purpose of explanation only and is not meant to imply architectural limitations with respect to the present disclosure.

A data processing system in accordance with an embodiment of the present disclosure includes an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as a version of Microsoft Windows™, a product of Microsoft Corporation located in Redmond, Wash. may be employed if suitably modified. The operating system is modified or created in accordance with the present disclosure as described.

LAN/WAN/Wireless adapter 112 can be connected to a network 130 (not a part of data processing system 100), which can be any public or private data processing system network or combination of networks, as known to those of skill in the art, including the Internet. Data processing system 100 can communicate over network 130 with server system 140, which is also not part of data processing system 100, but can be implemented, for example, as a separate data processing system 100.

Various disclosed embodiments include a “dialog display on hover” process that selectively displays information about an object on the data processing system display when the user “hovers” or pauses a cursor over the object using the pointing device. Various embodiments provide a new type of interactive control in a user interface of a data processing system referred to herein as an “Access Handle”. An access handle provides access to other controls or scene dialogs when activated. In various embodiments, either or both of the dialog display on hover or the access handle can be implemented; in some cases, the access handle is itself displayed or activated on a hover as described herein.

The hover process can display a configurable scene dialog or controls near the cursor when mouse movement pauses for a predetermined amount of time. The scene dialog is not contextual to what is under the cursor (e,g. like balloon information that appears when hovering over text or an icon), but is contextual to a specific command within a software application and the configuration thereof.

The scene dialog can remain on the screen until the cursor is moved away from the scene dialog (or other display) by a predetermined distance or until the user interacts with the software application, command, or scene dialog in such a way causing it to be dismissed based on context.

The hover process provides an interface allowing a command to present relevant, configurable options without any intervention or interaction from the user.

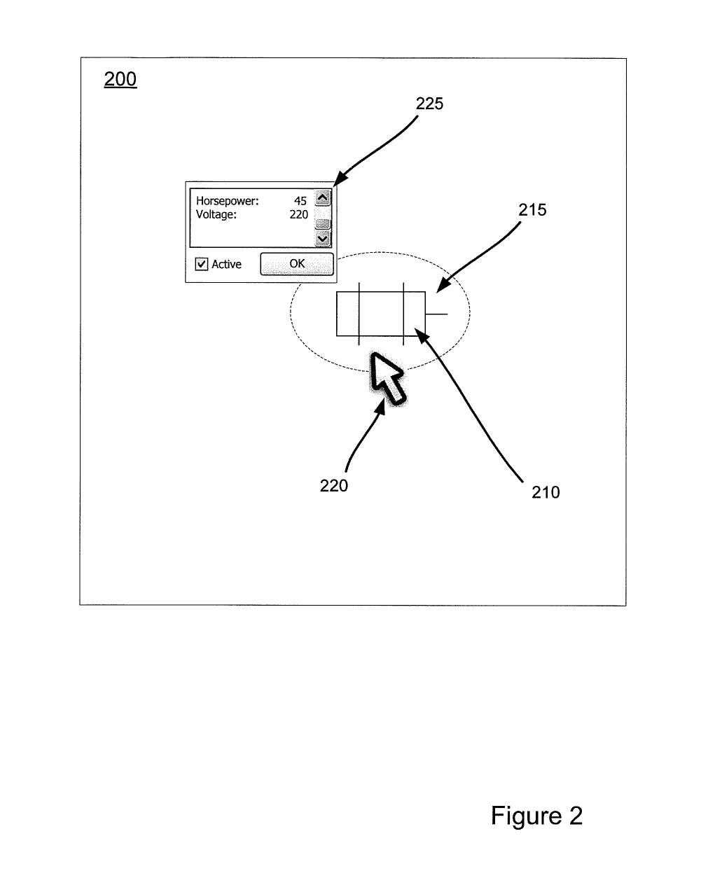

FIG. 2 illustrates an example of a simplified user interface 200. In this user interface is a target object 210, which is a motor in this example. The dashed line indicates a hover area 215 that surrounds the target object. When the pointer 220 is moved into the hover area 215 and then is held in place (paused or “hovered”) for a configurable amount of time, the system can respond by displaying a dialog 225. A typical amount of time is one second, and the dialog 225 can be any dialog or control, and in specific embodiments, is a configuration dialog for the target object 210.

In this example, the dialog 225 is a configuration dialog for the motor through which the user can enter configuration data or settings or perform other commands with respect to the target object. As illustrated therein, the dialog 225 receives configuration inputs, which are then saved by the system, such as horsepower and voltage, about the motor target object 210. Numerous other types of configuration inputs and settings about the target object are contemplated, including but not limited to, those relating to the physical, mechanical, and spatial properties of the target object. In various embodiments, dialog 225 may also accept commands to be performed on the target object, including but not limited to activating or deactivating the target object (e.g., turning it on or off), replicating the target object, protecting the target object from further revisions, or adding constraints or other relationships between the target object and other elements.

In various embodiments, the dialog 225 can have explicit “confirmation” or “dismiss” buttons, such as the “OK” button shown or a “cancel” button (not shown). Once dialog 225 is displayed, it can remain displayed until the system receives an input on the confirmation or dismiss buttons. In other cases, the dialog 225 can remain displayed until the pointer 220 is moved outside the hover area 215 for a configurable amount of time, for example five seconds, and/or at a configurable distance from the hover area; in such a case, the “life” of the dialog 225 is controlled by natural cursor movements, rather than explicit keyboard or mouse clicks. When the dialog is undisplayed by either of these techniques, any changes to configuration data for the target object 210 can be automatically saved by the system.

In some cases, the dialog 225 is included in the hover area 215 for determining whether to undisplay (hide) the dialog 225. In some cases, the hover area 215 can be larger or smaller than illustrated in this example. For example, the hover area 215 can be limited to the boundaries of the target object 210, or can be limited to the area of an access handle as described herein.

As the user is interacting with the system and previewing an object such as target object 210, the system displays a dialog 225 when the user “pauses” or “stops motion of” the pointer 220 during the interaction with the system. Options, selections, controls, configuration items, or other information is displayed in the dialog 225, and the system allows the user to configure the target object 210 by checking, entering, or selecting configuration data for the target object 210 in the dialog 225.

This hover process provides a unique interface allowing the system present relevant, configurable options without any intervention or interaction from the user.

The system can display access handles in the user interface, as associated with a target object. Disclosed access handles can behave differently from other handles in that, in some cases, they cannot be dragged or repositioned in the application work area. In some cases, they can embed other handle controls with them that are presented when activated, and they can be deactivated. In various embodiments, deactivation of one access handle is automatically performed when another access handle is activated.

Various embodiments use a dialog display on hover process as described above to activate an access handle by detecting the user hovering the cursor over the access handle. When an access handle is activated, the system displays related configuration items, controls, and other information related to the associated target object.

The disclosed access handles interface allows the system to present a lean, but rich set of on-screen controls, minimizing mouse travel and maintaining user focus.

In some embodiments, access handles appear on screen as other handles, but on hover, reveal controls that will be exposed when activated.

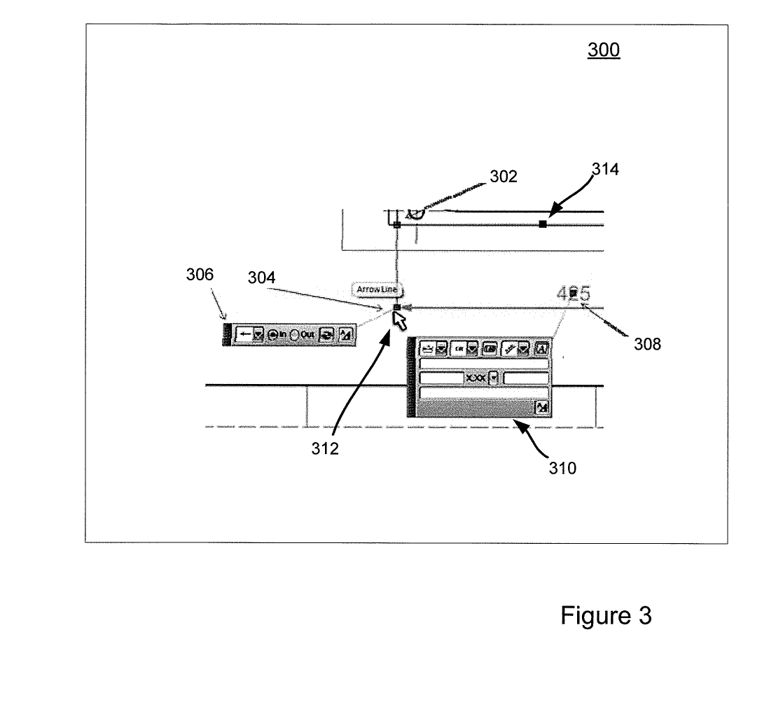

FIG. 3 illustrates an exemplary user interface 300 including access handles. In this example, access handles are shown as colored squares on a target object. Although not shown in this patent document, in a typical implementation, an inactive access handle is illustrated in a first color, such as gray or black, and an active access handle is illustrated in a second color, such as green or red.

In this example, access handle 302, shown on a corner of an associated partial target object, is an inactive access handle.

Access handle 304 is active since pointer 312 is hovering near it. The system responds by displaying dialog 306, which includes options, selections, controls, commands, configuration items, or other information for configuring or controlling the associated target object. The user can set or change any of these through the dialog 306 or can execute any commands in the dialog 306.

Similarly, in this example, access handle 308 is active and associated with a target object (the number “425”). In a typical implementation, unlike this example, only one access handle will be active at a given time, and any other active access handles are deactivated when a new access handle is activated. The system responds by displaying dialog 310, which includes options, selections, controls, configuration items, or other information for configuring or controlling the associated target object. In other cases, the dialog displayed when an access handle is activated can also or alternatively include such items as manipulation handles, other access handles, and other settings for the target object.

In some embodiments, when the system detects a pointer hovering over an access handle, the system can show a selection tip, with a unique name or identifier for the access handle. In some embodiments, when the system detects a pointer hovering over an access handle, the system can show a partially translucent preview of the dialog and any underlying handles that will be activated if that access handle were selected by being “clicked” on or otherwise selected by a user.

In some embodiments, when the system receives a single click or other selection of an access handle, it activates the access handle and displays the dialog with the associated controls or other information. In some embodiments, activating the access handle may cause managed handles (that is, other, conventional handles in the interface that are associated with the access handle) to become visible. A single conventional handle may be managed by, shared by, or otherwise associated with multiple access handles. In the context of FIG. 3, conventional handle 314 is displayed when access handle 308 is active. A conventional handle is also referred to as a “manipulation handle” herein.

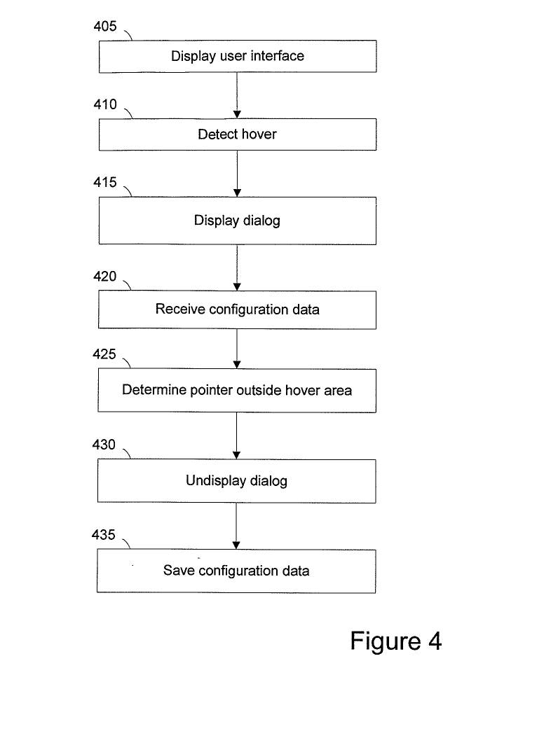

FIG. 4 illustrates a flowchart of a process in accordance with disclosed embodiments that may be performed, for example, by one or more PLM or PDM systems, referred to generically as “the system.”

The system displays a user interface including at least one target object having a hover area (405). The hover area can correspond to an access handle, the target object, or an area of the interface including and surrounding either of these.

The system detects that a user-controlled pointer is moved into the hover area and held in place for a first predetermined amount of time (410).

In response to the detection, the system can display a dialog associated with the target object (415). The dialog can include options, selections, controls, configuration items, or other information associated with the target object. Alternately or additionally, the system can display the dialog in response to detecting a user selection of an access handle. Alternately or additionally, this can include displaying one or more conventional handles in the user interface.

The system can receive configuration data from a user through the dialog (420). This can include the user configuring the target object by checking, entering, or selecting configuration data for the target object in the dialog.

The system can determine that the user-controller pointer is moved outside the hover area for a second predetermined amount of time (425).

In response to the determination, the system can undisplay the dialog (430). Alternately or additionally, the system can undisplay the dialog in response to receiving an explicit input from the user.

The system can save any received configuration data (435).

Of course, those of skill in the art will recognize that, unless specifically indicated or required by the sequence of operations, certain steps in the processes described above may be omitted, performed concurrently or sequentially, or performed in a different order.

Those skilled in the art will recognize that, for simplicity and clarity, the full structure and operation of all data processing systems suitable for use with the present disclosure is not being depicted or described herein. Instead, only so much of a data processing system as is unique to the present disclosure or necessary for an understanding of the present disclosure is depicted and described. The remainder of the construction and operation of data processing system 100 may conform to any of the various current implementations and practices known in the art.

It is important to note that while the disclosure includes a description in the context of a fully functional system, those skilled in the art will appreciate that at least portions of the mechanism of the present disclosure are capable of being distributed in the form of instructions contained within a machine-usable, computer-usable, or computer-readable medium in any of a variety of forms, and that the present disclosure applies equally regardless of the particular type of instruction or signal bearing medium or storage medium utilized to actually carry out the distribution. Examples of machine usable/readable or computer usable/readable mediums include: nonvolatile, hard-coded type mediums such as read only memories (ROMs) or erasable, electrically programmable read only memories (EEPROMs), and user-recordable type mediums such as floppy disks, hard disk drives, and compact disk read only memories (CD-ROMs) or digital versatile disks (DVDs).

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, or function is an essential element which must be included in the claim scope: the scope of patented subject matter is defined only by the allowed claims. Moreover, none of these claims are intended to invoke paragraph six of 35 USC §112 unless the exact words “means for” are followed by a participle.

What is claimed is:

1. A method for product data management, the method performed by a data processing system and comprising:
displaying a user interface, by the data processing system, including at least one target object having a hover area;
detecting, by the data processing system, that a user-controlled pointer is moved into the hover area and held in place for a first predetermined amount of time;
displaying, by the data processing system, a dialog associated with the target object in response to the detecting;
receiving configuration data, by the data processing system, from a user through the dialog; and
saving the received configuration data, by the data processing system.

2. The method of claim 1, wherein the data processing system also determines that the user-controller pointer is moved outside the hover area for a second predetermined amount of time, and in response, undisplays the dialog.

3. The method of claim 1, wherein the data processing system undisplays the dialog in response to receiving an input from the user.

4. The method of claim 1, wherein the data processing system receives a selection of an access handle associated with the target object and, in response, activates the access handle and displays at least one manipulation handle in the user interface.

5. The method of claim 1, wherein the dialog includes at least one of options, selections, controls, or configuration items associated with the target object.

6. The method of claim 1, wherein receiving configuration data includes the user configuring the target object by checking, entering, or selecting the configuration data for the target object in the dialog.

7. The method of claim 1, wherein the data processing system receives a selection of a first access handle associated with the target object and, in response, deactivates a second access handle in the user interface.

8. A data processing system comprising:
a processor; and
an accessible memory, the data processing system particularly configured to
display a user interface including at least one target object having a hover area;
detect that a user-controlled pointer is moved into the hover area and held in place for a first predetermined amount of time;
display a dialog associated with the target object in response to the detecting;
receive configuration data from a user through the dialog; and
save the received configuration data.

9. The data processing system of claim 8, wherein the data processing system also determines that the user-controller pointer is moved outside the hover area for a second predetermined amount of time, and in response, undisplays the dialog.

10. The data processing system of claim 8, wherein the data processing system undisplays the dialog in response to receiving an input from the user.

11. The data processing system of claim 8, wherein the data processing system receives a selection of an access handle associated with the target object and, in response, activates the access handle and displays at least one manipulation handle in the user interface.

12. The data processing system of claim 8, wherein the dialog includes at least one of options, selections, controls, or configuration items associated with the target object.

13. The data processing system of claim 8, wherein receiving configuration data includes the user configuring the target object by checking, entering, or selecting the configuration data for the target object in the dialog.

14. The data processing system of claim 8, wherein the data processing system receives a selection of a first access handle associated with the target object and, in response, deactivates a second access handle in the user interface.

15. A non-transitory computer-readable medium encoded with executable instructions that, when executed, cause one or more data processing systems to:
display a user interface including at least one target object having a hover area;
detect that a user-controlled pointer is moved into the hover area and held in place for a first predetermined amount of time;
display a dialog associated with the target object in response to the detecting;
receive configuration data from a user through the dialog; and
save the received configuration data.

16. The computer-readable medium of claim 15, wherein the data processing system also determines that the user-controller pointer is moved outside the hover area for a second predetermined amount of time, and in response, undisplays the dialog.

17. The computer-readable medium of claim 15, wherein the data processing system undisplays the dialog in response to receiving an input from the user.

18. The computer-readable medium of claim 15, wherein the data processing system receives a selection of an access handle associated with the target object and, in response, activates the access handle and displays at least one manipulation handle in the user interface.

19. The computer-readable medium of claim 15, wherein the dialog includes at least one of options, selections, controls, or configuration items associated with the target object.

20. The computer-readable medium of claim 15, wherein receiving configuration data includes the user configuring the target object by checking, entering, or selecting the configuration data for the target object in the dialog.
